(19) United States
(12) Patent Application Publication
(10) Pub. No.: US 2024/0378938 A1
(43) Pub. Date: Nov. 14, 2024

(54) SYSTEM AND METHOD FOR QR CODE VALIDATION AND TRACKING OF BEVERAGE DISPENSING

(71) Applicant: VALIDFILL LLC, Bradenton, FL (US)

(72) Inventors: Loren Ostema, Bradenton, FL (US); Gregory Edelson, Bradenton, FL (US); Tyler Wampler, Bradenton, FL (US); Roger Sears, Bradenton, FL (US); Randy Stich, Bradenton, FL (US)

(21) Appl. No.: 18/316,731

(22) Filed: May 12, 2023

(51) Int. Cl. G07F 9/00; G06Q 20/32

(52) U.S. Cl. CPC G07F 9/001; G06Q 20/3276

(57) ABSTRACT

Embodiments relate to a system and method for QR code validation and tracking of beverage dispensing. The system comprises a POS device and a server, wherein the POS device is in communication with the server. The POS device transfers a customer order to the server, and the server reviews the customer order for at least one target item. If at least one target item is found, the server generates a QR code and transfers the QR code to a code display device. The code display device displays the QR code such that a customer may scan the QR code with a customer device.

### CROSS REFERENCE TO RELATED APPLICATIONS

This application claims the benefit of U.S. Provisional Patent Application Ser. No. 63/348,656 filed on Jun. 3, 2022, the entire contents of which are incorporated herein by reference.

### FIELD OF THE INVENTION

Embodiments relate to systems and methods for validation and tracking of beverage dispensing, particularly to systems and methods for validation and tracking of beverage dispensing through quick response (QR) code technology.

### BACKGROUND OF THE INVENTION

Current systems and methods use identifiers, such as radio-frequency identification (RFID) tags, to validate and track beverage dispensing. However, these systems and methods provide for a high cost per beverage, a slow and/or inefficient dispensing process, and unreasonably limit personalization and enforcement of dispensing restrictions. While the emergence of QR code technology has alleviated issues in other industries, QR codes are easily shareable and susceptible to fraud, especially in the beverage dispensing setting. Accordingly, there is a need for a system and method to validate and track beverage dispensing that allow for a lower cost per drink (without sacrificing security concerns), a quick and efficient dispensing process, and personalization and dispensing restrictions, all while preventing fraudulent customer actions.

### SUMMARY OF THE INVENTION

Embodiments relate to a system and method for QR code validation and tracking of beverage dispensing. The system comprises a POS device and a server, wherein the POS device is in communication with the server. The POS device transfers a customer order to the server, and the server reviews the customer order for at least one target item. If at least one target item is found, the server generates a QR code and transfers the QR code to a code display device. The code display device displays the QR code such that a customer may scan the QR code with a customer device.

In an exemplary embodiment, a beverage dispensing system comprises a point-of-sale device, an application programming interface, wherein the point-of-sale device is configured to send a customer order to the application programming interface, a server, wherein the application programming interface is configured to send the customer order to the server and the server is configured to review the customer order for at least one target item. The server is further configured to generate a QR code corresponding to the at least one target item. The beverage dispensing system further comprises a code display device configured to display the QR code. In some embodiments, the at least one target item is a beverage.

In some embodiments, the server comprises a database configured to store the QR code.

In some embodiments, the beverage dispensing system further comprises a customer device configured to scan the QR code displayed on the code display device whereby the QR code is transferred from the code display device to the customer device.

In some embodiments, the customer device comprises an application configured to scan the QR code displayed on the code display device whereby the QR code is transferred from the code display device to the customer device.

In some embodiments, the application is configured to store the QR code.

In some embodiments, the beverage dispensing system further comprises a code scanning device configured to scan the QR code from the customer device whereby the QR code is transferred from the customer device to the code scanning device, wherein the code scanning device is configured the send the QR code to the application programming interface and wherein the application programming interface is configured to send the QR code to the server, and wherein the server is configured to review the QR code to determine if the QR code is valid.

In some embodiments, the beverage dispensing system further comprises a beverage dispensing machine in communication with the server, wherein the server is configured to send command signals to the beverage dispensing machine upon validating the QR code.

In some embodiments, the beverage dispensing machine is configured to dispense a beverage.

In some embodiments, the QR code comprises a time restriction.

In some embodiments, the QR code comprises a use restriction.

In an exemplary embodiments, a method of dispensing beverage comprises sending a customer order to an application programming interface from a point-of-sale device; sending the customer order to a server from the application programming interface; reviewing the customer order for at least one target item; generating a QR code, wherein the QR code corresponds to the at least one target item; and displaying the QR code with a code display device.

In some embodiments, the at least one target item is a beverage.

In some embodiments, the method further comprises scanning the QR code displayed on the code display device with a customer device; and transferring the QR code from the code display device to the customer device.

In some embodiments, the method further comprises storing the QR code on an application of the customer device.

In some embodiments, the method further comprises displaying the QR code on the customer device; scanning the QR code displayed on the customer device with a code scanning device; and transferring the QR code from the customer device to the code scanning device.

In some embodiments, the code scanning device is in communication with the application programming interface and the method further comprises sending the QR code from the code scanning device to the application programming interface; sending the QR code to the server; and reviewing the QR code to determine if the QR code is valid.

In some embodiments, the server is in communication with a beverage dispensing machine, and the method further comprises the server sending command signals to the beverage dispensing machine.

In some embodiments, the method further comprises dispensing a beverage from the beverage dispensing machine.

In some embodiments, the step of reviewing the QR code to determine if the QR code is valid comprises reviewing the QR code to determine if there are any enforceable restrictions.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows an exemplary system configured to validate and track beverage dispensing.

FIG. 2 shows a flow diagram detailing an exemplary embodiment of a method of QR code validation and tracking of beverage dispensing.

FIG. 3 shows a flow diagram detailing an exemplary embodiment of a method of QR code validation and tracking of beverage dispensing.

FIGS. 4(a) and 4(b) show an exemplary process flow of a customer obtaining access to a beverage dispenser using a QR code in accordance with aspects of the present disclosure, wherein FIG. 4(b) is a continuation of FIG. 4(a).

FIGS. 5(a) and 5(b) show an exemplary process flow of a customer obtaining a QR code in accordance with aspects of the present disclosure, wherein FIG. 5(b) is a continuation of FIG. 5(a).

### DETAILED DESCRIPTION OF THE INVENTION

The following description is of exemplary embodiments and methods of use that are presently contemplated for carrying out the present invention. This description is not to be taken in a limiting sense, but is made merely for the purpose of describing the general principles and features of various aspects of the present invention. The scope of the present invention is not limited by this description.

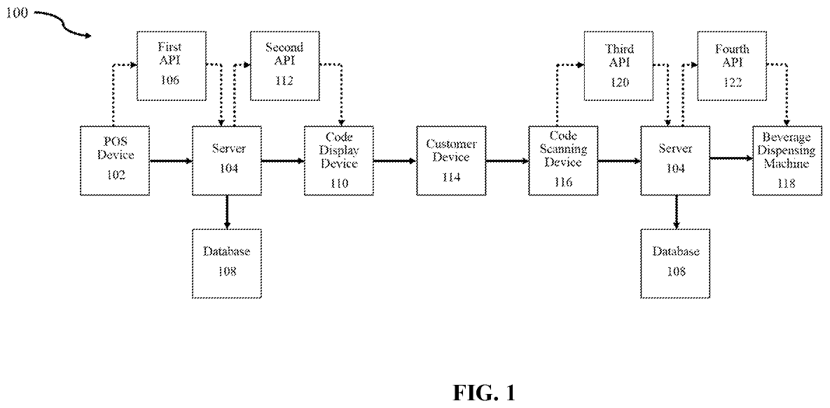

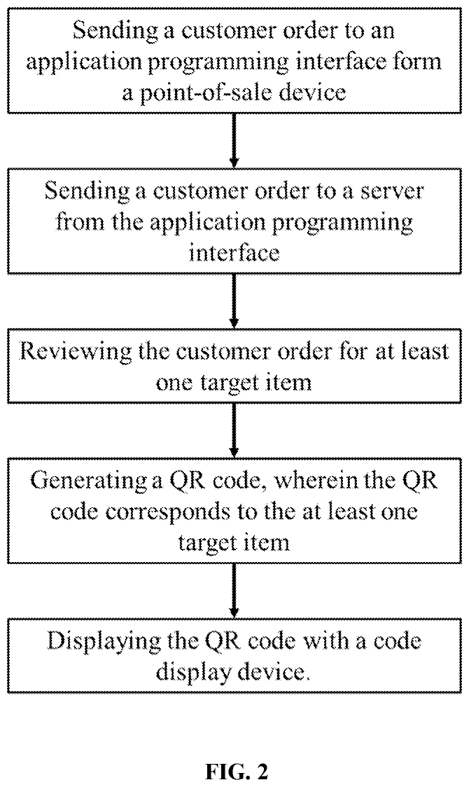

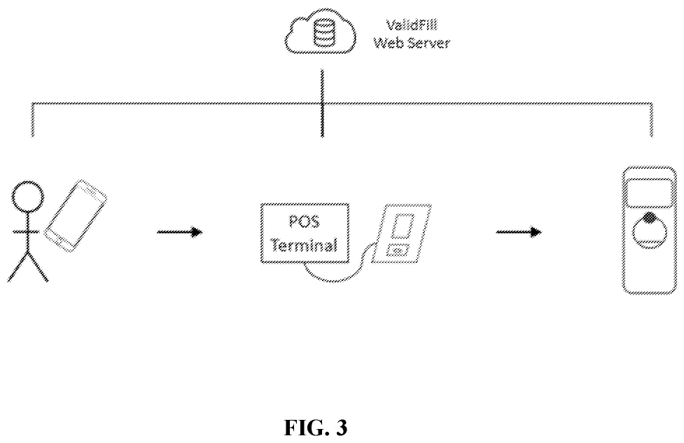

FIG. 1 shows an exemplary system configured to validate and track beverage dispensing, and FIG. 3 shows an exemplary flow diagram of a quick response (QR) code validation and tracking system in accordance with aspects of the present disclosure.

The system 100 comprises a point-of-sale (POS) system and a server 104. The POS system may comprise at least one POS device 102. The POS device 102 is configured for user interaction such that a user may use the POS device 102 to record a customer order. It is contemplated that the user may be a customer or some other user (e.g., a cashier, an employee, etc.). The POS device 102 may be in communication (e.g., wireless communication) with the server 104. The POS device 102 transfers the customer order to the server 104. Accordingly, it is contemplated that the server 104 receives the customer order from the POS device 102.

It is contemplated that the POS device 102 comprises a processor. An exemplary POS device 102 is a cash register, kiosk, terminal, tablet, smart phone, or any other suitable POS device. It if further contemplated that the server 104 comprises a processor.

After the POS device 102 transfers the customer order to the server 104, the server 104 reviews the customer order for at least one target item. A target item may by any beverage product or beverage related product, such as at least one beverage or at least one refill of a beverage, which may be included in a customer order. It is understood that the target item may be pre-defined (e.g., defined prior to the server receiving the customer order), such that the server 104 may immediately review the customer order for at least one target item. If at least one target item is not found, the server 104 takes no further action with regard to the customer order. If at least one target item is found, the server 104 is configured to generate a QR code. It is contemplated that the QR code may correspond to the at least one target item of the customer order. For example, if one beverage is found in the customer order, the QR code would correspond to the one beverage; if two beverages are found in the customer order, the QR code would correspond to the two beverages; if one refill is found in the customer order, the QR code would correspond to the one refill; and so on. In one embodiment the server 104 may generate one QR code per customer order, even if more than one target items are found in the customer order. In another embodiment, the server 104 may generate one QR code per target item.

The POS device 102 may further be used to generate a promotion. It is understood that a promotion may be any beverage product or beverage related product, such as at least one beverage or at least one refill of a beverage, which is typically provided by a business, restaurant, producer, etc. at free or reduced charge. The POS device 102 transfers the promotion to the server 104. Accordingly, it is contemplated that the server 104 receives the promotion from the POS device 102. After the POS device 102 transfers the promotion to the server 104, the server 104 reviews the promotion for at least one target item. If at least one target item is not found, the server 104 takes no further action with regard to the promotion. If at least one target item is found, the server 104 is configured to generate a QR code. It is contemplated that the QR code may correspond to the at least one target item of the promotion. For example, if one beverage is found in the promotion, the QR code would correspond to the one beverage; if two beverages are found in the promotion, the QR code would correspond to the two beverages; if one refill is found in the promotion, the QR code would correspond to the one refill; and so on. It is contemplated that the server 104 generates one QR code per promotion, even if more than one target items are found in the promotion.

In one embodiment, the system 100 may comprise a first application programming interface (API) 106. It is contemplated that the first API 106 may be a software intermediary between the POS device 102 and the server 104 such that the server 104 may not be in direct communication with the POS device 102. It is contemplated that the POS device 102 may transfer the customer order and/or promotion to the first API 106, and the first API 106 may transfer the customer order to the server 104.

The server 104 may further comprise at least one database 108. A database 108 may be configured to store information, including but not limited to target item(s), customer order information, promotion information, QR codes, restrictions on QR codes, QR code status, order status, beverage information, pricing, etc. The database 108 may be configured to carry out, facilitate, assist, etc. any of the actions/steps undertaken by the server 104.

The POS system further comprises a code display device 110. It is contemplated that the code display device 110 is a separate device than the POS device 102. The code display device 110 may be in communication (e.g., wired communication or wireless communication) with the POS device 102. The code display device 110 may be in communication (e.g., wireless communication) with the server 102. After the server 104 generates a QR code, the server 104 may transfer the QR code to the code display device 110. Accordingly, it is contemplated that the code display device 110 receives the QR code from the server 104 and thereafter displays the QR code.

In another embodiment, the first API 106 may further be a software intermediary between the code display device 110 and the server 104 such that the code display device 110 may not be in direct communication with the server 104. It is contemplated that the server 104 may transfer the QR code to the first API 106, and the first API 106 may transfer the QR code to the code display device 110. In yet another embodiment, the system 100 may comprise a second API 112. The second API 112 may be a software intermediary between the code display device 110 and the server 104 such that the code display device 110 may not be in direct communication with the server 104. It is contemplated that the server 104 may transfer the QR code to the second API 112, and the second API 112 may transfer the QR code to the code display device 110. It is contemplated that the second API 114 may be the same or substantially the same as the first API 106.

The code display device 110 may comprise a screen or other medium configured to display the QR code. In an alternative embodiment, after the server 104 generates a QR code, the server 104 transfers the QR code to the second API 112, and the second API 112 transfers the QR code to the code display device 110. Accordingly, it is contemplated that the code display device 110 receives the QR code from the second API 112 and thereafter displays the QR code.

After the code display device 110 displays the QR code, a customer may scan the QR code with a customer device 114 (e.g., a mobile device). Accordingly, it is contemplated that the screen or other medium configured to display the QR code may display the QR code in a way such that it may be scanned by a customer. Upon a customer successfully scanning the QR code displayed by the code display device 110, the code display 110 device transfers the QR code to the customer device 114 and the QR code is removed from and no longer displayed on the code display device 110. In other words, an individual QR code may only be scanned once by one customer using one customer device 114.

It is contemplated that the code display device 110 comprises a processor. It is further contemplated that the customer device 114 comprises a processor. An exemplary customer device 114 is a smartphone, tablet, laptop, smart watch, or any other suitable customer device.

It is contemplated that the QR code transferred to the customer device 114 may be divided into more than one QR codes when more than one target item was found by the server 104 in the customer order and/or promotion. It is contemplated that a QR code transferred to the customer device 114 may divided into the same number of target items found in the customer order and/or promotion (e.g., one QR code per target item found) such that a QR code may later be viewed and displayed individually.

It is contemplated that each QR code generated by the server 104 is unique. In other words, each generated QR code is linked 1 to 1 with a specific customer and/or customer order/promotion.

It is contemplated that the QR code displayed by the code display device 110 may be any color, such as blue, black, or any other suitable color or combinations thereof. It is contemplated that the color of the QR code displayed by the code display device 110 may comprise a dark color and may further comprise a light background such that the QR code may be more easily scanned by the customer device 114.

It is contemplated that the code display device 110 may comprise a covering, such as shrouds, a hood, overlays, etc., to keep light away from the code display device 110. It is further contemplated that the covering may assist a customer in positioning the customer device 114 to scan the displayed QR code. It is contemplated that excess movement by a customer and/or customer device 114 and/or excess light may make it difficult to scan the displayed QR code.

It is contemplated that the customer device 114 may comprise an application. The application may store (e.g., save) one or more QR codes after a QR code is scanned by the customer device 114. It is contemplated that the customer may view and/or display a QR code via the application. It is further contemplated that the application may comprise display settings configured to change the display (e.g., color) of the QR code. It is further contemplated that the application may comprise personalization settings configured to personalize the QR code.

A first customer may transfer a QR code to a second customer. It is understood that a first customer is the customer who scanned the QR code displayed by the code display device 110 with a customer device 114. It is contemplated that the second customer may have a second customer device (e.g., a mobile device). It is contemplated that the second customer device comprises a processor. An exemplary second customer device is a smartphone, tablet, laptop, smart watch, or any other suitable customer device. In an exemplary embodiment, the first customer may display a QR code stored on the application of the first customer device 114 such that the second customer may scan the QR code with the second customer device. Upon a second customer successfully scanning the QR code displayed by the application of the first customer device 114, the first customer device transfers the QR code to the second customer device and the QR code is removed from the first customer device 114. In other words, the QR code may only be scanned one time after the QR code is stored in the application of the first customer device 114. In an alternative embodiment, the first customer may send (e.g., via text message, email, Bluetooth methods, etc.) a QR code stored on the application of the first customer device 114 to a second customer device. Upon a second customer successfully accepting the QR code sent by the first customer, the QR code is removed from the first customer device 114. In others words, the QR code may only be sent one time after the QR code is stored in the application of the first customer device 114.

It is contemplated that by transferring a QR code to a second customer, the first customer is not allowing the second customer to access the first customer device 114, nor is the second customer allowing the first customer to access the second customer device. It is further contemplated that the first customer device 114 and the second customer device may not be paired, and the only interaction between the customer devices is the transfer of QR code(s).

In exemplary embodiments, a QR code may comprise at least one restriction. It is contemplated that the restriction(s) may be established contemporaneously with the generation of a QR code.

It is contemplated that the restriction may be a time restriction, wherein a QR code is configured to self-delete and/or invalidate if not used before a defined time. The defined time may be a time of day or a duration of time. For example, the QR code may comprise a time restriction that requires a customer to use the QR code within 1 minute, 30 minutes, 1 hour, 2 hours, etc., and the QR code may self-delete after the duration of time expires, or the QR code may be invalid if used after the duration of time expires. It is contemplated that a time restriction may be an effective way to combat fraud, and the shorter the time restriction, the more protected a QR code will be.

It is contemplated that the restriction may be a use restriction, wherein a QR code is configured to self-delete and/or invalidate after one use or a defined number of uses. For example, the QR code may comprise a use restriction that allows a customer to use the QR code twice, and the QR code may self-delete after the second use, or the QR code may be invalid after the second use. It is contemplated that a use restriction may be an effective way to combat fraud.

It is contemplated that the restriction may be a sugar tax restriction wherein a QR code is configured to self-delete and/or invalidate if a user uses the QR code in excess of a defined volume or a defined quantity of sugar beverage(s). For example, the QR code may comprise a quantity limitation that prohibits a user from using the QR code to dispense more than three sugar beverages, and the QR code may self-delete after the third sugar beverage, or the QR code may be invalid after the third sugar beverage.

It is contemplated that the restriction may be a location restriction wherein a QR code is configured to self-delete and/or invalidate if a user uses the QR code outside of a defined geographic location. For example, the QR code may comprise a location restriction that only allows a user to use the QR code at defined parks, restaurants, dispensing machines, etc.

It is contemplated that the restriction may be a transfer restriction wherein a QR code is configured to self-delete and/or invalidate if a user transfers the QR code to another user. For example, the QR code may comprise a transfer restriction that only allows a first customer to use the QR code.

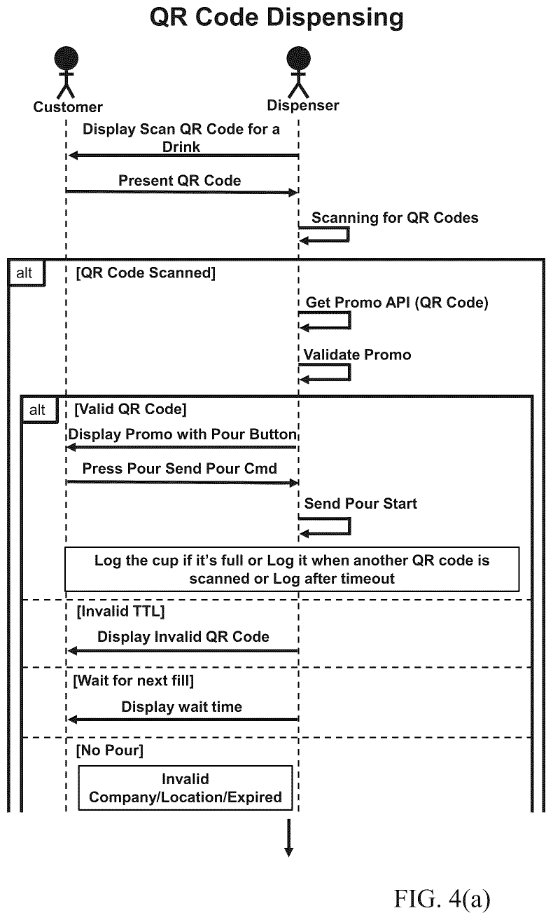

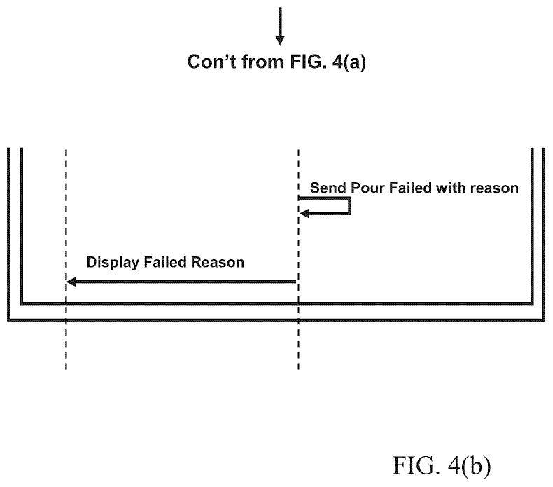

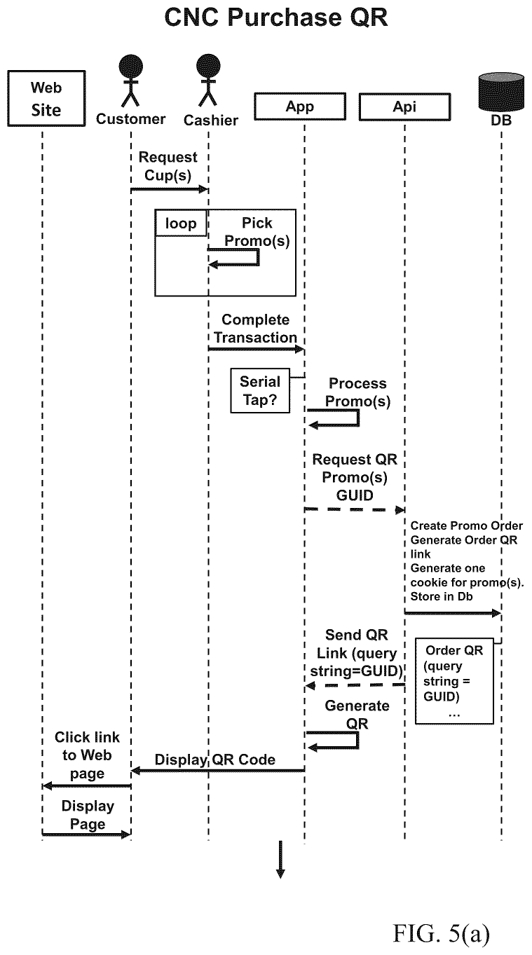

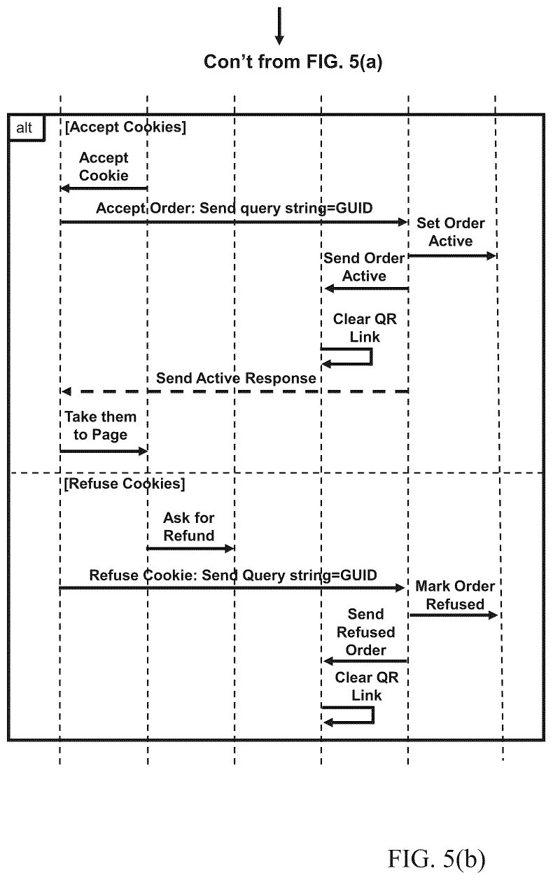

FIGS. 4(a) and 4(b) show an exemplary diagram of a customer using to a beverage dispensing machine 118 by utilizing a QR code in accordance with aspects of the present disclosure. After a QR code is transferred from the code display device 110 to a customer device 114, a customer may present the QR code to a beverage dispensing machine 118. The beverage dispensing machine 118 comprises a code scanning device 116, wherein the code scanning device 116 is in communication (e.g., wired communication or wireless communication) with the beverage dispensing machine 118. The code scanning device 116 may be a separate device than the beverage dispensing machine 118, or the code scanning device 116 may be integrated with the beverage dispensing machine 118. The code scanning device 116 is configured to scan a QR code. The customer may present a QR code on the customer device 114 to the code scanning device 116, and the code scanning device 116 may scan the QR code.

It is contemplated that a customer may present a QR code on the application of the customer device 114 to the code scanning device 116, and the code scanning device 116 may scan the QR code from the application.

It is contemplated that the code scanning device 116 comprises a processor. An exemplary code scanning device 116 comprises a camera.

The code scanning device 116 is in communication (e.g., wireless communication) with the server 104. After a QR code is scanned by the code scanning device, the code scanning device 116 communicates with the server 104 to determine if the QR code is valid. A valid QR code is one that has not yet been used and/or one that is free of any enforceable restrictions (e.g., at least one restriction, described above). The server 104 and/or the database 108 reviews the QR code to determine if the QR code is valid.

The beverage dispensing machine 118 is in communication (e.g., wireless communication) with the server 104. If a QR code is valid, the server 104 may send command signals to the beverage dispensing machine (e.g., direct the beverage dispensing machine 118 to allow use by the customer, actuate the beverage dispensing machine 118, etc.). If a QR code is invalid, the server 104 may not send command signals to the beverage dispensing machine 118 or may send a signal that the QR code is invalid.

It is contemplated that a QR code may correspond to the at least one target item of the customer order and/or promotion. For example, if one beverage was found in the customer order and/or promotion, the QR code would correspond to the one beverage and scanning the QR code with the code scanning device 116 will grant a customer access to the beverage dispensing machine 118 to dispense one beverage; if one refill was found in the customer order and/or promotion, the QR code would correspond to the one refill and scanning the QR code with the code scanning device 116 will grant a customer access to the beverage dispensing machine 118 to dispense one refill; and so on.

In another embodiment, the first API 106 may further be a software intermediary between the code scanning device 116 and the server 104 such that the server 104 may not be in direct communication with the code scanning device 116. It is contemplated that code scanning device 116 may transfer the QR code to the first API 106, and the first API 106 may transfer the QR code to the server 104. In yet another embodiment, the system 100 may comprise a third API 120. It is contemplated that the third API 120 may be a software intermediary between the code scanning device 116 and the server 104 such that the server 104 may not be in direct communication with the code scanning device 116. It is contemplated that the code scanning device 116 may transfer the QR code to the third API 120, and the third API 120 may transfer the QR code to the server 104. It is contemplated that the third API 120 may be the same or substantially the same as the first API 106 and/or the second API 112.

In another embodiment, the first API 106 may further be a software intermediary between the server 104 and the beverage dispensing machine 118 such that the server 104 may not be in direct communication with the beverage dispensing machine 118. It is contemplated that the server 104 send command signals to the first API 106, and the first API 106 may transfer the command signals to the beverage dispensing machine 118. In yet another embodiment, the system 100 may comprise a fourth API 122. It is contemplated that the fourth API 122 may be a software intermediary between the server 104 and the beverage dispensing machine 118 such that the server 104 may not be in direct communication with the beverage dispensing machine 118. It is contemplated that the server 104 send command signals to the fourth API 122, and the fourth API 122 may transfer the command signals to the beverage dispensing machine 118. It is contemplated that the fourth API 122 may be the same or substantially the same as the first API 106 and/or the second API 112 and/or the third API 120.

The beverage dispensing machine 118 is configured to dispense at least one beverage. The beverage dispensing machine 118 may have an actuator (e.g., a button, a lever, etc.) configured to actuate the beverage dispensing machine 118 such that a beverage is dispensed from a nozzle when a customer engages the actuator. The actuator may be a physical button or virtual button displayed by a screen or other interface of the beverage dispensing machine 118. Specifically, the actuator may be in communication with a valve (e.g., a flow control valve) such that the flow control valve permits flow and dispensing of a beverage when a customer engages the actuator. It is contemplated that the beverage dispensing machine 118 comprises a processor.

An exemplary beverage dispensing machine 118 is a fountain drink dispenser or any other suitable beverage dispensing machine.

The beverage dispensing machine 118 may further comprise a screen or other interface configured to display information (e.g., textual information) and/or messages to a customer. If a QR code is valid, the screen or other interface may direct the customer to perform an action, such as to pour/dispense a beverage, select a beverage, etc. If a QR code is invalid, the screen or other interface may display an error message (e.g., a message explaining why the QR code is invalid). The screen may display any other information, including but not limited to information regarding restrictions (i.e., remaining fills, wait time, etc.). The screen or other interface may be a touch-screen.

It is contemplated that the server 104 may store information, such as information regarding time of scanning, beverage dispensed, etc., in the database 110.

It is contemplated that the server 104 and the beverage dispensing machine 118 may communicate to track a customer's actions. For example, the beverage dispensing machine 118 may communicate information to the server 104 regarding beverage choice, amount dispensed, geographic location, or any other relevant information.

In an exemplary embodiment, after a QR code is used, the QR code is no longer valid for future uses. In other words, only the first customer to scan a QR code at a beverage dispensing machine 118 and/or initiate beverage dispensing at a beverage dispensing machine 118 may use the QR code. It is contemplated that a one-time-use QR code may be an effective way to combat fraud (e.g., copying a QR code to multiple devices).

In an exemplary embodiment, it is contemplated that once the code scanning device 116 successfully scans a QR code from the customer device 114, the QR code is removed from the customer device 114. In other words, a QR code may only be scanned one time after the QR code is transferred to the customer device 114. It is further contemplated that once the code scanning device 116 successfully scans a QR code from the application of the customer device 114, the QR code is removed from application of the customer device 114. In other words, a QR code may only be scanned one time after the QR code is stored on the application of the customer device 114. In an alternative embodiment, it is contemplated that once a beverage dispensing machine 118 begins dispensing the target item, the QR code is removed from the application/customer device 114. In other words, a QR code may only initiate dispensing one time after the QR code is transferred to the customer device 114 and/or stored on the application of the customer device 114.

It is contemplated that a QR code displayed by the application and/or the customer device 114 may be any color, such as blue, black, or any other suitable color or combinations thereof. It is contemplated that the color of the QR code displayed by the application and/or the customer device 114 may comprise a dark color and may further comprise a light background such that the QR code is more easily scanned by the code scanning device 116.

It is contemplated that the code scanning device 116 may comprise a covering, such as shrouds, a hood, overlays, etc., to keep light away from the code scanning device 116. It is further contemplated that the covering may assist a customer in positioning the customer device 114 to present a QR code to the displayed code scanning device 116. It is contemplated that excess movement by a customer and/or customer device 114 and/or excess light may make it difficult to present a QR code to the displayed code scanning device 116.

It is contemplated that the code scanning device 116 is positioned such that it may not get wet and/or dirty from dispensed beverages.

In an alternative embodiment, it is contemplated that the above disclosure may be incorporated in embodiments wherein a QR code is placed on a beverage cup. The beverage cup may be a non-disposable cup (e.g., souvenir cup) or a disposable cup (e.g., paper cups, plastic cups, etc.).

Another embodiment of the system 100 can include use of two or more QR codes attached (e.g., adhered to, printed on, pained on, embedded within, etc.) to a beverage cup. Any one or combination of QR codes can be the same or different from another one or combination of QR codes. For example, the system 100 can include two QR codes, each QR code being unique (e.g., each QR code is different from the other QR code). Thus, the server 104 is configured to generate a first QR code and a second QR code. Each of these QR codes can be attached to the beverage cup. The first and second QR codes can be attached to the beverage cup and the beverage cup presented to the user at the POS device 102. The beverage dispensing machine 118 can include one or more code scanning devices 116. A user can insert the beverage cup within the beverage dispensing machine 118, wherein access to the beverage dispensing machine 118 to dispense beverage occurs only when both the first and second QR codes are detected. The code scanning device(s) 116 can scan for the first and second QR codes in series (e.g., scan for the first QR code first then the second QR code), simultaneously (e.g., one scanning device 116 scans for both first and second QR codes at the same time), or in parallel (e.g., two scanning devices 116 scan for their respective QR code at the same time), etc. The first and second QR codes can be positioned on the beverage cup such that proper scanning of them will require alignment with two scanning devices 116 simultaneously. This would preclude a user from capturing an image of the two QR codes attached to the beverage cup with their camera (e.g., smartphone) and attempting to gain fraudulent access to the dispensing machine 118 by inserting their smartphone in the scanning area of the scanning device(s) 116, as the dispensing machine's 118 scan area can be configured to only allow a beverage cup to fit inside; and not two smartphones, or at least not allow two smartphone to be placed inside the scan area and oriented to align with the scanning device(s) 116. In addition, or in the alternative, the QR code(s) placed on the beverage cup can be located on a portion of the cup that is contoured, wherein the scanning device(s) 116 are required to move in a sweeping motion to property scan the QR code. This, again, will preclude a user from capturing an image of the QR code and using their smartphone to fraudulently gain access to the dispensing machine 118, as the captured image will be distorted, or the flat surface of the smartphone display will not present the QR code in a manner conducive to the sweeping scan.

While the target item described is referred to as a beverage product, it is envisioned that the target item can be any type of food item that can be dispensed in connection with the QR code system and method described herein. While the dispensed item described is referred to as a beverage, it is envisioned that the dispensed item can be any type of food item that can be dispensed in connection with the QR code system and method described herein. While the dispensing machine described is referred to as a beverage dispensing machine, it is envisioned that the dispensing machine can be any machine that can dispense any food item in connection with the QR code system and method described herein.

Any of the processors disclosed herein can be part of or in communication with a machine (e.g., a computer device, a logic device, a circuit, an operating module (hardware, software, and/or firmware), etc.). The processor can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. The processor can receive, process, and/or store data related to the QR code.

It should be noted that use of processors herein can include any one or combination of a Graphics Processing Unit (GPU), a Field Programmable Gate Array (FPGA), a Central Processing Unit (CPU), etc. The processor can include one or more processing or operating modules. A processing or operating module can be a software or firmware operating module configured to implement any of the functions disclosed herein. The processing or operating module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Embodiments of the memory can include a processor module and other circuitry to allow for the transfer of data to and from the memory 300, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

The computer or machine readable medium can be configured to store one or more instructions thereon. The instructions can be in the form of algorithms, program logic, etc. that cause the processor to execute any of the functions disclosed herein.

Any of the processors can be in communication with other processors of other devices (e.g., a computer device, a computer system, a laptop computer, a desktop computer, etc.). For instance, the processor of the POS device can be in communication with the processor of the server, the processor of the server can be in communication with the processor of the customer device, etc. Any of the processors can have transceivers or other communication devices/circuitry to facilitate transmission and reception of wireless signals. Any of the processors can include an API as a software intermediary that allows two or more applications to talk to each other. Use of an API can allow software of the processor of the system to communicate with software of the processor of the other device(s).

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A beverage dispensing system, comprising:
a point-of-sale device;
an application programming interface, wherein the point-of-sale device is configured to send a customer order to the application programming interface;
a server, wherein the application programming interface is configured to send the customer order to the server and the server is configured to review the customer order for at least one target item, and wherein the server is configured to generate a QR code corresponding to the at least one target item; and
a code display device configured to display the QR code.

2. The beverage dispensing system of claim 1, wherein the at least one target item is a beverage.

3. The beverage dispensing system of claim 1, wherein the server comprises a database configured to store the QR code.

4. The beverage dispensing system of claim 1, further comprising:
a customer device configured to scan the QR code displayed on the code display device whereby the QR code is transferred from the code display device to the customer device.

5. The beverage dispensing system of claim 4, wherein the customer device comprises an application configured to scan the QR code displayed on the code display device whereby the QR code is transferred from the code display device to the customer device.

6. The beverage dispensing system of claim 5, wherein the application is configured to store the QR code.

7. The beverage dispensing system of claim 4, further comprising:
a code scanning device configured to scan the QR code from the customer device whereby the QR code is transferred from the customer device to the code scanning device,
wherein the code scanning device is configured the send the QR code to the application programming interface and wherein the application programming interface is configured to send the QR code to the server, and
wherein the server is configured to review the QR code to determine if the QR code is valid.

8. The beverage dispensing system of claim 7, further comprising:
a beverage dispensing machine in communication with the server, wherein the server is configured to send command signals to the beverage dispensing machine upon validating the QR code.

9. The beverage dispensing system of claim 8, wherein the beverage dispensing machine is configured to dispense a beverage.

10. The beverage dispensing system of claim 1, wherein the QR code comprises a time restriction.

11. The beverage dispensing system of claim 1, wherein the QR code comprises a use restriction.

12. A method of dispensing a beverage, comprising:
sending a customer order to an application programming interface from a point-of-sale device;
sending the customer order to a server from the application programming interface;
reviewing the customer order for at least one target item;
generating a QR code, wherein the QR code corresponds to the at least one target item; and
displaying the QR code with a code display device.

13. The method of dispensing a beverage of claim 12, wherein the at least one target item is a beverage.

14. The method of dispensing a beverage of claim 12, further comprising:
scanning the QR code displayed on the code display device with a customer device; and
transferring the QR code from the code display device to the customer device.

15. The method of dispensing a beverage of claim 14, further comprising:
storing the QR code on an application of the customer device.

16. The method of dispensing a beverage of claim 14, further comprising:
displaying the QR code on the customer device;
scanning the QR code displayed on the customer device with a code scanning device; and
transferring the QR code from the customer device to the code scanning device.

17. The method of dispensing a beverage of claim 16, wherein the code scanning device is in communication with the application programming interface, further comprising:
sending the QR code from the code scanning device to the application programming interface;
sending the QR code to the server; and
reviewing the QR code to determine if the QR code is valid.

18. The method of dispensing a beverage of claim 17, wherein the server is in communication with a beverage dispensing machine, further comprising;
the server sending command signals to the beverage dispensing machine.

19. The method of dispensing a beverage of claim 18, further comprising;
dispensing a beverage from the beverage dispensing machine.

20. The method of dispensing a beverage of claim 16, wherein the step of reviewing the QR code to determine if the QR code is valid comprises reviewing the QR code to determine if there are any enforceable restrictions.
